(19) United States
(12) Patent Application Publication
(10) Pub. No.: US 2016/0063150 A1
(43) Pub. Date: Mar. 3, 2016

(54) ENHANCED OIL RECOVERY USING DIGITAL CORE SAMPLE

(71) Applicants: SCHLUMBERGER TECHNOLOGY CORPORATION, Sugar Land, TX (US); SHELL OIL COMPANY, Houston, TX (US)

(72) Inventors: Sergey Sergeevich Safonov, Moscow (RU); Oleg Yirievich Dinariev, Moscow (RU); Nikolay Vyacheslavovich Evseev, Moscow (RU); Omer M. Gurpinar, Denver, CO (US); Dmitry Anatolievich Koroteev, Moscow (RU); Steffen Berg, Voorburg (NO); John Justin Freeman, Pattison, TX (US); Cornelius Petrus Josephus Walthera Van Kruijsdijk, Delft (NL); Michael T. Myers, Houston, TX (US); Lori Hathon, Houston, TX (US); Denis Vladimirovich Klemin, Houston (US)

(21) Appl. No.: 14/784,009

(22) PCT Filed: Apr. 12, 2013
(86) PCT No.: PCT/RU2013/000316

§ 371 Date: Oct. 12, 2015

(51) Int. Cl. G06F 17/50; E21B 43/16

(52) U.S. Cl. CPC G06F 17/5009; E21B 43/16

(57) ABSTRACT

Performing an enhanced oil recovery (EOR) injection operation in an oilfield having a reservoir may include obtaining a EOR scenarios that each include a chemical agent, obtaining a three-dimensional (3D) porous solid image of a core sample, and generating a 3D pore scale model from the 3D porous solid image. The core sample is a 3D porous medium representing a portion of the oilfield. The 3D pore scale model describes a physical pore structure in the 3D porous medium. Simulations are performed using the EOR scenarios to obtain simulation results by, for each EOR scenario, simulating, on the first 3D pore scale model, the EOR injection operation using the chemical agent specified by the EOR scenario to generate a simulation result. A comparative analysis of the simulation results is performed to obtain a selected chemical agent. Further, an operation is performed using the selected chemical agent.

### BACKGROUND

Operations, such as geophysical surveying, drilling, logging, well completion, and production, are performed to locate and gather valuable downhole fluids. Surveys are often performed using acquisition methodologies, such as seismic mapping, resistivity mapping, etc. to generate images of underground formations. These formations are often analyzed to determine the presence of subterranean assets, such as valuable fluids or minerals, or to determine whether the formations have characteristics suitable for storing fluids. Although the subterranean assets are not limited to hydrocarbons such as oil, throughout this document, the terms “oilfield” and “oilfield operation” may be used interchangeably with the terms “field” and “field operation” to refer to a site where any types of valuable fluids or minerals can be found and the activities required to extract them. The terms may also refer to sites where substances are deposited or stored by injecting them into the surface using boreholes and the operations associated with this process. Further, the term “field operation” refers to a field operation associated with a field, including activities related to field planning, wellbore drilling, wellbore completion, and/or production using the wellbore.

In an oilfield, initial production of the hydrocarbons is accomplished by “primary recovery” techniques wherein the natural forces present in the reservoir are used to produce the hydrocarbons. However, upon depletion of these natural forces and the termination of primary recovery, a large portion of the hydrocarbons remains trapped within the reservoir. In addition, many reservoirs lack sufficient natural forces to be produced by primary methods from the very beginning. Recognition of these facts has led to the development and use of many enhanced oil recovery (EOR) techniques.

Most of the EOR techniques involve injection of at least one fluid into the reservoir to force hydrocarbons towards and into a production well, such as the miscible water alternating gas (MWAG) or Alkali-Surfactant-Polymer (ASP) injection operations, for example. Fluid is injected carefully so that the fluid forces the hydrocarbons toward the production well but does not prematurely reach the production well before at least most of the hydrocarbons have been produced. Generally, once the fluid reaches the production well, production is adversely affected as the injected fluids are not generally sellable products and in some cases can be difficult to separate from the produced oil. Over the years, many have attempted to calculate the optimal pumping rates for injector wells and production wells to extract the most hydrocarbons from a reservoir. There is considerable uncertainty in a reservoir as to its geometry and geological parameters (e.g., porosity, rock permeabilities, etc.). In addition, the market value of hydrocarbons can vary dramatically and so financial factors may be used in determining how production should proceed to obtain the maximum value from the reservoir.

As described above, a large number of variables and large quantities of data are involved in analyzing oilfield operations. It is, therefore, often useful to model the behavior of the oilfield operation to determine the desired course of action. During the ongoing operations, the operating conditions may need adjustment as conditions change and new information is received. For example, models of subsurface hydrocarbon reservoirs and oil wells are often used in simulation (e.g., in modeling oil well behavior) to increase yields and to accelerate and/or enhance production from oil wells. Seismic interpretation tools and seismic-to-simulation programs, such as PETREL® (a registered trademark of Schlumberger Technology Corporation, Houston, Tex.), can include numerous functionalities and apply complex techniques across many aspects of modeling and simulating. Such programs may include a large suite of tools and may be referred to as exploration and production (E&P) tools.

At present, many decisions concerning the application of EOR techniques are made based on laboratory studies, pilot projects, field trials, and reservoir simulation at the macro-scale. This approach is severely affected by natural restrictions on the use of laboratory data. Namely, experimental core studies of EOR techniques lead to irreversible changes of core samples, precluding reliable comparison of different methods. There are also practical considerations whereby reservoir conditions for planned EOR processes (high pressure or/and high temperature, aggressive media etc.) cannot be adequately reproduced in a laboratory. In addition, reservoir simulation at the macro-scale uses a continuous medium model to represent porous solid in an oil field formation without considering underlying pore structures. Such simplified modeling technique leads to inaccuracies in the simulation results.

### SUMMARY

In general, in one aspect, embodiments relate to performing an enhanced oil recovery (EOR) injection operation in an oilfield having a reservoir. Performing the EOR injection operation may include obtaining a EOR scenarios that each include a chemical agent, obtaining a three-dimensional (3D) porous solid image of a core sample, and generating a 3D pore scale model from the 3D porous solid image. The core sample is a 3D porous medium representing a portion of the oilfield. The 3D pore scale model describes a physical pore structure in the 3D porous medium. Simulations are performed using the EOR scenarios to obtain results by, for each EOR scenario, simulating, on the first 3D pore scale model, the EOR injection operation using the chemical agent specified by the EOR scenario to generate a simulation result. A comparative analysis of the simulation results is performed to obtain a selected chemical agent. Further, an operation is performed using the selected chemical agent.

This summary is provided to introduce a selection of concepts that are further described below in the detailed description. This summary is not intended to be used as an aid in limiting the scope of the claimed subject matter.

### BRIEF DESCRIPTION OF DRAWINGS

FIGS. 1.1-1.3 show schematic diagrams of a system in accordance with one or more embodiments.

FIG. 2 shows a flowchart in accordance with one or more embodiments.

FIG. 3 shows an example diagram in accordance with one or more embodiments.

FIG. 4 shows a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of one or more embodiments, numerous specific details are set forth in order to provide a more thorough understanding. However, it will be apparent to one of ordinary skill in the art that embodiments may be practiced without these specific details. In other instances, well-known features have not been described in detail to avoid unnecessarily complicating the description.

In general, embodiments provide a method and system for analyzing multiple chemical agents on a single core sample for enhanced oil recovery (EOR). Specifically, one or more embodiments obtain EOR scenarios that each includes a chemical agent and a core sample. From the core sample, a three-dimensional (3D) porous solid image of the core sample is obtained. The 3D porous solid image is used to generate a pore scale model showing realistic 3D geometry of pore-grain structure within the sample. Using the pore scale model, simulations are performed using the different chemical agents, EOR gases or liquids with specific physical properties at high-pressure high-temperature conditions, to identify the optimal chemical agent.

EOR, as used in this application, refers to sophisticated techniques that alter the original properties of oil. EOR techniques may be employed during at any time during the productive life of an oil reservoir. EOR may be used to restore formation pressure, and improve oil displacement or fluid flow in the reservoir. EOR may be performed using a chemical agent, such as a type of alkaline flooding or micellar-polymer flooding. Optimal application of the chemical agent may depend on properties of the reservoir, such as temperature, pressure, depth, net pay, permeability, residual oil and water saturations, porosity and fluid properties, such as oil API gravity and viscosity. EOR may be referred to as improved oil recovery or tertiary recovery.

A core sample, as used in this application, refers to a 3D porous medium representing a portion of the oilfield. In particular, a core sample refers to a physical sample obtained from a portion of the oilfield. For example, the core sample may be obtained by drilling into the portion of the oilfield with a core drill to extract the core sample from the portion.

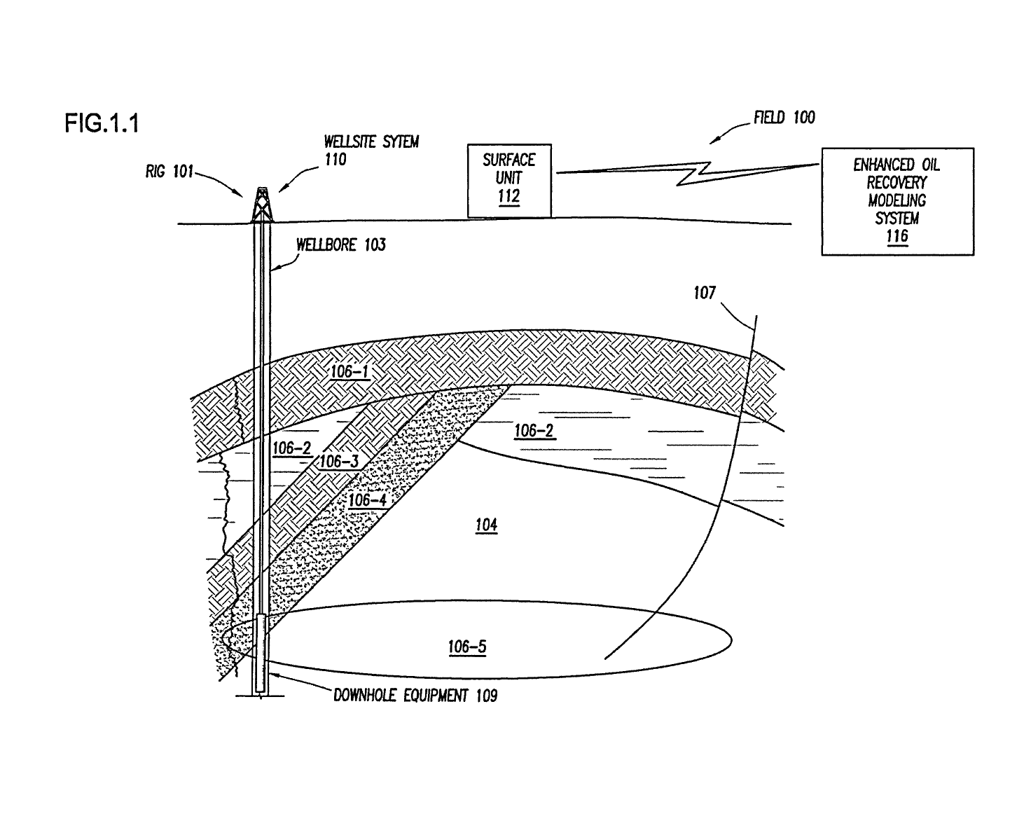

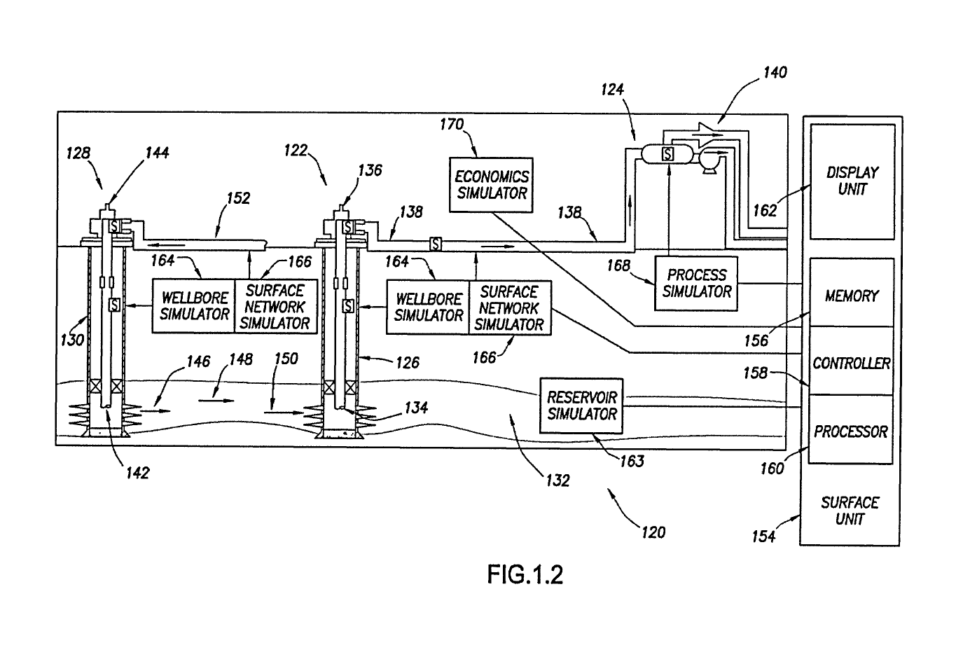

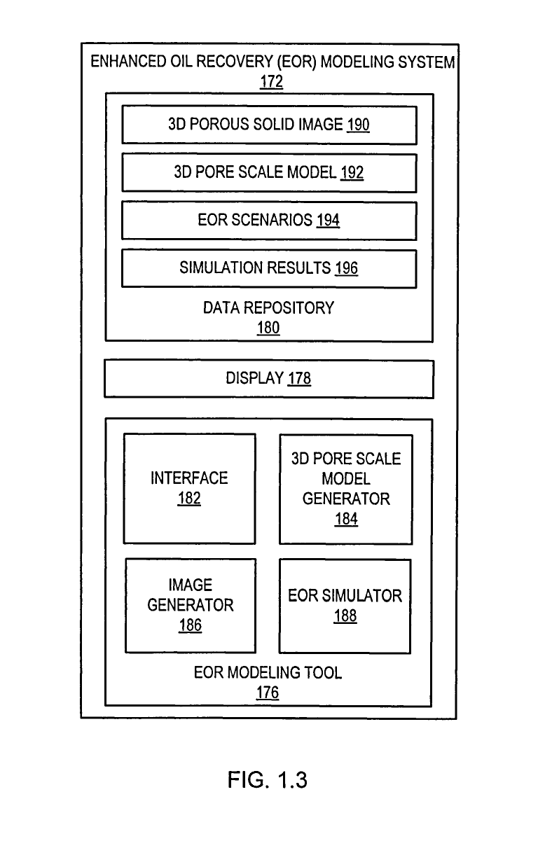

FIG. 1.1 depicts a schematic view, partially in cross section, of a field (100) in which one or more embodiments of user sourced data issue management may be implemented. In one or more embodiments, one or more of the modules and elements shown in FIG. 1.1 may be omitted, repeated, and/or substituted. Accordingly, embodiments of user sourced data issue management should not be considered limited to the specific arrangements of modules shown in FIG. 1.1.

As shown in FIG. 1.1, the subterranean formation (104) includes several geological structures (106-1 through 106-4). As shown, the formation includes a sandstone layer (106-1), a limestone layer (106-2), a shale layer (106-3), and a sand layer (106-4). A fault line (107) extends through the formation. In one or more embodiments, various survey tools and/or data acquisition tools are adapted to measure the formation and detect the characteristics of the geological structures of the formation. As noted above, the outputs of these various survey tools and/or data acquisition tools, as well as data derived from analyzing the outputs, are considered as part of the historic information.

Further, as shown in FIG. 1.1, the wellsite system (110) is associated with a rig (101), a wellbore (103), and other wellsite equipment and is configured to perform wellbore operations, such as logging, drilling, fracturing, production, or other applicable operations. Generally, survey operations and wellbore operations are referred to as field operations of the field (100). These field operations may be performed as directed by the surface unit (112).

In one or more embodiments, the surface unit (112) is operatively coupled to an EOR modeling system (116) and/or a wellsite system (110). In particular, the surface unit (112) is configured to communicate with the EOR modeling system (116) and/or the wellsite system (110) to send commands to the EOR modeling system (116) and/or the wellsite system (110) and to receive data therefrom. For example, the wellsite system (110) may be adapted for measuring downhole properties using logging-while-drilling (“LWD”) tools and for obtaining core samples. In one or more embodiments, the surface unit (112) may be located at the wellsite system (110) and/or remote locations. The surface unit (112) may be provided with computer facilities for receiving, storing, processing, and/or analyzing data from the EOR modeling system (116), the wellsite system (110), or other part of the field (100). The surface unit (112) may also be provided with or functionally for actuating mechanisms at the field (100). The surface unit (112) may then send command signals to the field (100) in response to data received, for example to control and/or optimize various field operations described above.

In one or more embodiments, the data received by the surface unit (112) represents characteristics of the subterranean formation (104) and may include seismic data and/or information related to porosity, saturation, permeability, natural fractures, stress magnitude and orientations, elastic properties, etc. during a drilling, fracturing, logging, or production operation of the wellbore (103) at the wellsite system (110).

In one or more embodiments, the surface unit (112) is communicatively coupled to the EOR modeling system (116). Generally, the EOR modeling system (116) is configured to analyze, model, control, optimize, or perform other management tasks of the aforementioned field operations based on the data provided from the surface unit (112). Although the surface unit (112) is shown as separate from the EOR modeling system (116) in FIG. 1.1, in other examples, the surface unit (112) and the EOR modeling system (116) may also be combined.

FIG. 1.2 shows a schematic view of a portion of the oilfield (120) of FIG. 1.1, depicting a producing wellsite (122) and surface network (124) in detail. The wellsite (122) of FIG. 1.2 includes a wellbore (126) extending into the earth therebelow. In addition, FIG. 1.2 shows an injection wellsite (128) having an injection wellbore (130). As shown, the wellbores (126) and (130) has already been drilled, completed, and prepared for production from reservoir (132).

Wellbore production equipment (134) extends from a wellhead (136) of wellsite (122) and to the reservoir (132) to draw fluid to the surface. The wellsite (122) is operatively connected to the surface network (124) via a transport line (138). Fluid flows from the reservoir (132), through the wellbore (126), and onto the surface network (124). The fluid then flows from the surface network (124) to the process facilities (140).

As described above, fluid may be injected through an injection wellbore, such as the wellbore (130) to gain additional amounts of hydrocarbon. Fluid may be injected to sweep hydrocarbons to producing wells and/or to maintain reservoir pressure by balancing extracted hydrocarbons with injected fluid. The wellbore (130) may be a new well drilled specifically to serve as an injection wellbore, or an already existing well that is no longer producing hydrocarbons economically. As shown in FIG. 1.2, wellbore injection equipment (142) extends from a wellhead (144) of injection wellsite (128) to inject fluid (e.g., shown as (146) and (148) in FIG. 1.2) in or around the periphery of the reservoir (132) to push hydrocarbons (e.g., shown as (150) in FIG. 1.2) toward a producing wellbore, such as the wellbore (126). The injection wellsite (128) is operatively connected to an injection transport line (152), which provides the injection fluid to the injection wellsite (128) through the wellhead (144) and down through the well injection equipment (142).

The injected fluid may include any chemical agent, such as water, steam, gas (e.g., carbon dioxide), polymer, surfactant, other suitable liquid, or any combinations thereof. A substance that is capable of mixing with hydrocarbons remaining in the well is called miscible. For example, a surfactant (e.g., shown as (146) in FIG. 1.2), a chemical similar to washing detergents, can be injected into a reservoir mixing with some of the hydrocarbons locked in rock pores (e.g., shown as (148) in FIG. 1.2), and releases the hydrocarbons so that fluid (e.g., shown as (150) in FIG. 1.2) can be pushed towards the producing wells. One technique in fluid injection is miscible water alternating gas (MWAG) injection, which involves the use of gases such as natural gas (i.e., naturally occurring mixture of hydrocarbon gases), carbon dioxide, or other suitable gases. The injected gas (e.g., natural gas, carbon dioxide, etc.) mixes with some of the remaining hydrocarbons in the reservoir, unlocks it from the pores, and pushes the fluid (e.g., shown as (150) in FIG. 1.2) to producing wells. Water (e.g., shown as (146) in FIG. 1.2) is often injected behind the gas (e.g., shown as (148) in FIG. 1.2) to push the miscible gas and unlocked hydrocarbons along based on the incompressible nature of water.

The efficacy of the MWAG injection in recovering remaining hydrocarbons from an oilfield depends on careful planning of the injection schedules such as the selection of fluid, the determination of the composition of the fluid to ensure the miscibility, the pumping rate, the switching cycles between different injected fluid, the controlled interface, and capillary forces between different injected fluid, etc. The MWAG injection schedule should be determined considering geological and geo-physical information, such as temperature, pressure, porosity, permeability, composition, etc. In addition to the complexity in determining MWAG injection schedules, the source of the injection fluid, the constraints of the processing facilities and surface network, and market value of oil can affect the overall performance of the oilfield operation.

An integrated simulation method described below, may be used, for example, to model the MWAG injection operation including various aspects of the oilfield, such as geological, geo-physical, operational, financial, etc. In the integrated simulation method, various constraints of the oilfield operation may be considered, such as the network constraints, the processing facility constraints, the fluid source constraints, the reservoir constraints, the market price constraints, the financial constraints, etc.

As further shown in FIG. 1.2, sensors (S) are located about the oilfield (120) to monitor various parameters during oilfield operations. The sensors (S) may measure, for example, pressure, temperature, flow rate, composition, and other parameters of the reservoir, wellbore, surface network, process facilities and/or other portions of the oilfield operation. The sensors (S) are operatively connected to a surface unit (154) for collecting data therefrom. The surface unit may be, for example, similar to the surface unit (134) of FIG. 1.1.

One or more surface units (154) may be located at the oilfield (120), or linked remotely thereto. The surface unit (154) may be a single unit, or a complex network of units used to perform the modeling, planning, and/or management functions (e.g., in MWAG injection scheduling) throughout the oilfield (120). The surface unit (154) may be a manual or automatic system. The surface unit (154) may be operated and/or adjusted by a user. The surface unit (154) is adapted to receive and store data. The surface unit (154) may also be equipped to communicate with various oilfield equipment. The surface unit (154) may then send command signals to the oilfield in response to data received or modeling performed. For example, the MWAG injection schedule may be adjusted and/or optimized based on modeling results updated according to changing parameters throughout the oilfield, such as geological parameters, geo-physical parameters, network parameters, process facility parameters, injection fluid parameters, market parameters, financial parameters, etc.

As shown in FIG. 1.2, the surface unit (154) has computer facilities, such as memory (156), controller (158), processor (158), and display unit (162), for managing the data. The data is collected in memory (156), and processed by the processor (158) for analysis. Data may be collected from the oilfield sensors (S) and/or by other sources. For example, oilfield data may be supplemented by historical data collected from other operations, or user inputs.

The analyzed data (e.g., based on modeling performed) may then be used to make decisions. A transceiver (not shown) may be provided to allow communications between the surface unit (154) and the oilfield (120). The controller (158) may be used to actuate mechanisms at the oilfield (120) via the transceiver and based on these decisions. In this manner, the oilfield (120) may be selectively adjusted based on the data collected. These adjustments may be made automatically based on computer protocol and/or manually by an operator. In some cases, well plans are adjusted to select optimum operating conditions or to avoid problems.

To facilitate the processing and analysis of data, simulators may be used to process the data for modeling various aspects of the oilfield operation. Specific simulators are often used in connection with specific oilfield operations, such as reservoir or wellbore simulation. Data fed into the simulator(s) may be historical data, real time data or combinations thereof. Simulation through one or more of the simulators may be repeated or adjusted based on the data received.

As shown, the oilfield operation is provided with wellsite and non-wellsite simulators. The wellsite simulators may include a reservoir simulator (163), a wellbore simulator (164), and a surface network simulator (166). The reservoir simulator (163) solves for hydrocarbon flow through the reservoir rock and into the wellbores. The wellbore simulator (164) and surface network simulator (166) solves for hydrocarbon flow through the wellbore and the surface network (124) of pipelines. As shown, some of the simulators may be separate or combined, depending on the available systems.

The non-wellsite simulators may include process (168) and economics (170) simulators. The processing unit has a process simulator (168). The process simulator (168) models the processing plant (e.g., the process facilities (140)) where the hydrocarbon(s) is/are separated into its constituent components (e.g., methane, ethane, propane, etc.) and prepared for sales. The oilfield (120) is provided with an economics simulator (170). The economics simulator (170) models the costs of part or the entire oilfield (120) throughout a portion or the entire duration of the oilfield operation. Various combinations of these and other oilfield simulators may be provided.

FIG. 1.3 shows a schematic diagram of the EOR modeling system (172) in accordance with one or more embodiments. As discussed above, the EOR modeling system (172) may include at least a portion of the surface unit shown and described in relation to FIG. 1.1 and FIG. 1.2. As shown in FIG. 1.3, the EOR modeling system (172) includes an EOR modeling tool (176), data repository (180), and display (178). Each of these elements is described below.

In one or more embodiments, the EOR modeling tool (176) is a tool for performing EOR modeling for the oilfield. The EOR modeling tool may include hardware, software, or a combination of both. For example, the hardware may include a computer processor (not shown) and memory (not shown). The hardware may include a core sample scanner configured to generate a 3D porous solid image from a core sample. A 3D porous solid image is a 3D digital representation of the core sample. Specifically, the 3D porous solid image is an image of each portion of the core sample including pores and solid surfaces. Thus, the 3D porous solid image may show pores and rock boundaries of the core sample for each layer of the core sample. In accordance with one or more embodiments, the core sample scanner may scan the core sample with or without destroying the core sample in the process. In one or more embodiments, the software of the may include an interface (182), a 3D pore scale model generator (184), an image generator (186), and an EOR simulator (188), and an image generator (186). The software components may execute on the computer processor and use the memory.

Continuing with FIG. 1.3, the interface (182) may include a user interface and/or an application programming interface (API). The interface includes functionality to receive input and transmit output, such as to display (178). For example, the input may be the 3D porous solid image (190) of one or more core samples, EOR scenarios (188), and other information. The output may correspond to graphical representation of simulation results for display on the display (178), commands to send to the wellsite for controlling production, and other output.

The 3D pore scale model generator (184) corresponds to software that includes functionality to generate a 3D pore scale model from the 3D porous solid image. A 3D pore scale model describes the core sample. Specifically, whereas the 3D porous solid image may show the physical structure of the core sample, the 3D pore scale model may include the lithology of the core sample. For example, the lithographic properties of the core sample may include pore size distribution, rock type, tortuosity measurements, statistical results generated from the properties, and other information.

In one or more embodiments, the 3D pore scale model generator is connected to an EOR simulator (188). The EOR simulator (188) includes functionality to simulate injection of one or more chemical agents into the portion of the oilfield using the 3D pore scale model. The EOR simulator (188) may include functionality to simulate the injection directly from the 3D pore scale model or from a region model for the entire the portion of the oilfield. Specifically, the EOR simulator (188) may include functionality to generate the region model using the 3D pore scale model and simulate the injection operation on the region model. In one or more embodiments, the EOR simulator (188) may further include functionality to perform an economics analysis of the injection operation using one or more chemical agents. Specifically, the economics analysis may include projected costs (e.g., cost of the chemical agent, cost of the operating the tools to perform the injection, and other costs) and revenue (e.g., based on projected production amounts) for using each chemical agent.

In one or more embodiments, the image generator (186) includes functionality to generate two dimensional (2D) and/or 3D images from the simulation results. For example, the image generator (186) may include functionality to generate images showing the injection operation through the 3D pore scale model and/or the region model.

Continuing with FIG. 1.3, the various components of the EOR modeling tool (176) may include functionality to store and retrieve data from the data repository (180). In one or more embodiments, the data repository (180) is any type of storage unit and/or device (e.g., a file system, database, collection of tables, or any other storage mechanism) for storing data. Further, the data repository (180) may include multiple different storage units and/or devices. The multiple different storage units and/or devices may or may not be of the same type or located at the same physical site. As shown in FIG. 1.3, the data repository (180) includes functionality to store one or more 3D porous solid images (190), one or more 3D pore scale models (192), EOR scenarios (194), and simulation results (196).

As discussed above, the 3D porous solid images (190) are 3D images of core samples. Further, the 3D pore scale models (192) are models of the core sample For example, if multiple core samples are used, each core sample may have a unique associated 3D porous solid image of the core sample and a unique associated 3D pore scale model of the core sample.

In one or more embodiments, the EOR scenarios (194) correspond to a potential input for the injection operation. For example, the EOR scenario may include an identifier of a chemical agent. The identifier of the chemical agent may be a molecular formula, a name, definition of properties of the chemical agent (e.g., viscosity, surface tension, chemical composition, and other properties). In one or more embodiments, the EOR scenario may identify a portion of the oilfield, an injection parameter, and/or other static values for a particular simulation.

In one or more embodiments, the simulation results (196) are results of performing one or more simulations. For example, the simulation results (196) may define the optimal chemical agent and/or EOR scenario. Further, the simulation results (196) may include information about the simulation, such as expected gross and net revenue, costs, time, information describing the lithographic results of the injection operation (e.g., effect on formation) using the chemical agent, expected interactions, and/or other results.

While FIGS. 1.1-1.3 show a configuration of components, other configurations may be used without departing from the scope of embodiments. For example, various components may be combined to create a single component. As another example, the functionality performed by a single component may be performed by two or more components.

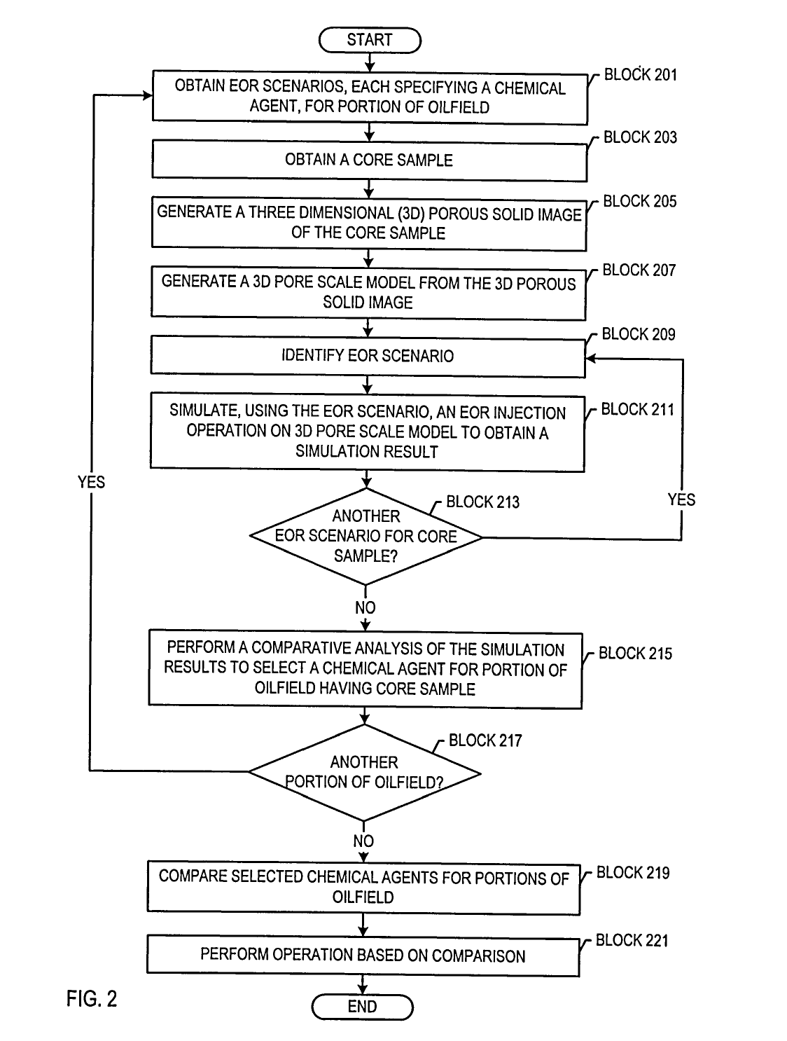

FIG. 2 shows a flowchart in accordance with one or more embodiments.

While the various blocks in this flowchart are presented and described sequentially, one of ordinary skill will appreciate that at least a portion of the blocks may be executed in different orders, may be combined or omitted, and at least as portion of the blocks may be executed in parallel. Furthermore, the blocks may be performed actively or passively. For example, some blocks may be performed using polling or be interrupt driven in accordance with one or more embodiments. By way of an example, determination blocks may not require a processor to process an instruction unless an interrupt is received to signify that condition exists in accordance with one or more embodiments. As another example, determination blocks may be performed by checking a data value to test whether the value is consistent with a tested condition in accordance with one or more embodiments.

In Block 201, EOR scenarios, each specifying a chemical agent, are obtained in one or more embodiments. In one or more embodiments, a user may submit the EOR scenarios to test. For example, using the user interface and for each EOR scenario, the user may enter or select the name of the chemical agent and any other parameters for the EOR scenario. In the example, the EOR modeling system includes or is able to obtain from a third party system properties of the chemical agent, such as viscosity and other properties. Thus, the user does not need to provide such properties.

In one or more embodiments, rather than the user providing the EOR scenarios, the EOR scenarios may be pre-defined in the EOR modeling system. For example, the EOR modeling system may use information about chemical agents from other oilfields to generate automatically a list of chemical agents for simulating.

In Block 203, a core sample is obtained in accordance with one or more embodiments. The core sample may be obtained by drilling at the oilfield and extracting a core sample. The core sample is provided to the EOR modeling tool.

In Block 205, a 3D porous solid image of the core sample is obtained in accordance with one or more embodiments. Obtaining the 3D porous solid image may be accomplished by scanning the core sample. For example, X-ray micro tomography, 3D nuclear magnetic resonance (NMR) imaging, 3D reconstruction from petrographic thin-section analysis and confocal microscopy, 3D reconstruction from analysis of 2D element maps acquired by Scanning-Electron Microscopy (SEM) with Energy-dispersive X-ray spectroscopy (EDX) function, or other technique or combination of techniques may be used to obtain the 3D porous solid image.

In Block 207, a 3D pore scale model is generated from the 3D porous solid image. To obtain the 3D pore scale model, digital processing and morphological analysis of the 3D porous solid image may be performed. Specifically, consecutive application of image filtering, segmentation and multiple property recognition may be used to obtain a digital 3D model of 3D porous solid image. Morphological and geometrical statistical property analysis may further be performed to obtain information, such as pore size distribution, local and average tortuosity measurement, grain size distribution, and other properties of the core sample.

In Block 209, an EOR scenario is identified. The identified EOR scenario is an EOR scenario that has not yet been used to perform the simulation. In Block 211, using the EOR scenario, an EOR injection operation is performed on the 3D pore scale model to obtain a simulation result.

As discussed above, Block 211 may be performed, for example, by performing the simulation directly on the 3D pore scale model or by generating a region model for the portion of the oilfield based on the 3D pore scale model. Generating a region model may be performed by upscaling the pore scale model to represent the entire region. In one or more embodiments, the simulation is performed using the hydrodynamic equations found in Alexander Demianov et al., Density Functional Modelling in Multiphase Compositional Hydrodynamics, 89 Can. J. Chem. Eng., 206, 211-12 (April 2011). In the hydrodynamic equations, the specific properties of the chemical agent in the EOR scenario are used to estimate how the chemical agent flows through the core sample, and, subsequently, the portion of the oilfield, in the EOR injection operation.

In order to perform mathematical modeling, explicit values or analytical expressions that are dependent on local temperature and local molar densities may be used for the following quantities: bulk Helmholtz energy density, volume and shear viscosity (or other rheological properties including effects like adsorption elongation viscosity, viscoelastisity, size exclusion effect etc.), thermal and diffusion transport coefficients, surface tension at the contact between fluid and rock and between different fluids. For these quantities, experimental values or experimentally validated correlations in respect to temperature and molar densities are used in one or more embodiments.

In order to obtain material parameters experimentally, standard and well established laboratory methods, such as mass density obtained by buoyancy or acoustic principles, may be used. Shear viscosity may be obtained from the drag force of a fluid past a surface and is also dependent on shear rate (shear rheology). Advanced rheological characterization of non-Newtonian reservoir and EOR fluids may be performed using rotary viscometers, core flooding, measurements of adsorption, flooding within channels of controlled geometry, such as microfluidic experiments, capillary viscometers, and other techniques. Pendant drop tensiometers and drop shape analysis may be used to determine the interfacial tension and contact angle between fluid/fluid and fluid/fluid/solid. Validated correlations may be obtained or derived from data reported in the openly accessible literature and/or proprietary data. Experiments may also include pressure, volume, and temperature (PVT) characterization of the reservoir and EOR fluids.

In one or more embodiments, the simulation result of a simulation includes the rate of displacement and the residual oil saturations for an EOR scenario. In other words, the simulation result defines how well a particular chemical agent performs with any other parameters in the EOR scenario involving the EOR injection operation. The simulation result may also include economics analysis, such as an estimation of costs and gross revenue from using the particular chemical agent.

In Block 213, a determination is made whether to process another EOR scenario for the core sample in one or more embodiments. Specifically, the determination is made whether another unprocessed EOR scenario exists. If the determination is made to process another EOR scenario, then the flow may repeat with Block 209.

In Block 215, a comparative analysis of the simulation results is performed to select a chemical agent for the portion of the oilfield having the core sample in one or more embodiments. The comparative analysis may select the chemical agent that provides the optimal displacement and residual oil saturation, the greatest projected revenue, has another optimal feature, or has a combination of optimal features. In one or more embodiments, if the comparative analysis includes a combination of features, for each EOR scenario, each feature is assigned a feature score that defines a rank of the EOR scenario for the feature. Further, a weighted average of the feature scores may be performed to obtain a score for the EOR scenario. The EOR scenario having the optimal weighted average may be deemed optimal for the portion of the oilfield. The chemical agent in the optimal EOR scenario is selected as the optimal chemical agent.

In Block 217, a determination is made whether to consider another portion of the oilfield. Specifically, core samples may be obtained from different portions of the oilfield. By obtaining different core samples, embodiments may account for the heterogeneity of the characteristics of the rock in the different portions of the oilfield. If a determination is made to consider another portion of the oilfield, then the flow may repeat with Block 201.

In Block 219, the selected chemical agents are compared for the portions of the oilfield. In particular, in one or more embodiments, the comparison is performed across the chemical agent that is deemed optimal in Block 211 for each portion of the oilfield. In one or more embodiments, if a majority of the portions of the oilfield has the same corresponding optimal chemical agent, then the optimal chemical agent may be selected for the oilfield. If variations exist, then the oilfield may be divided into parts, whereby each part includes one or more portions of the oilfield. An optimal chemical agent may be selected for the part based on the majority or unanimity of the optimal selected chemical agent across the portions of the oilfield in the particular part of the oilfield.

In Block 221, an operation is performed based on the comparison. The operation may be storing the selected chemical agent, defining a strategy for the oilfield based on the selected chemical agent, and/or performing an injection operation using the selected chemical agent. For example, defining a strategy may include specifying the chemical agent, the pressure, when the chemical agent will be injected, measurements for which to test, and any other strategic information. The strategy may be stored at the EOR modeling system, sent to the surface system, and/or sent to the wellsite. In one or more embodiments, the injection operation may be performed automatically, such as by the EOR modeling tool sending instructions to equipment at the wellsite, or manually.

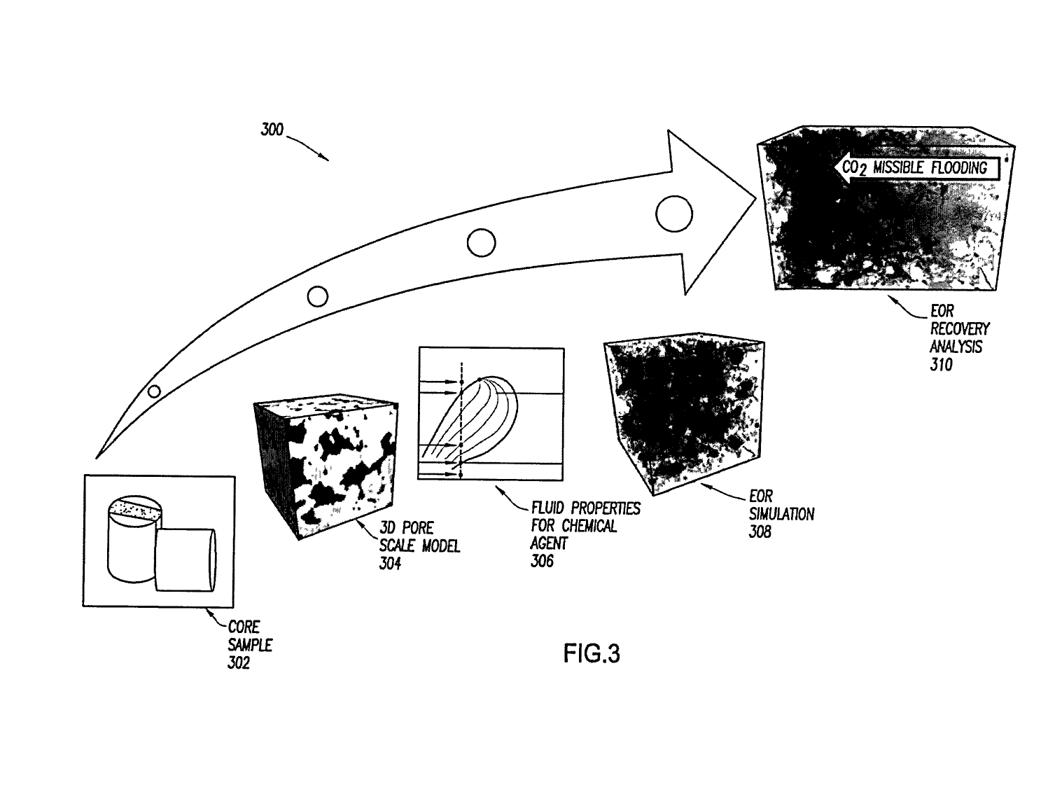

FIG. 3 shows an example diagram in accordance with one or more embodiments. The following examples are for explanatory purposes only and not intended to limit the scope of the claims. As shown in FIG. 3, a 3D core sample (302) is obtained from the oilfield. From the 3D core sample, a 3D pore scale model is generated (304). As shown in the example FIG. 3, the example 3D pore scale model shows sections of the core sample that have rock, sections that have oil, and sections that have water.

Continuing with the example, fluid properties of a chemical agent are identified (306) and used to perform an EOR simulation (308) on the 3D pore scale model (304). Based on the simulation or as part of the simulation, an EOR recovery analysis is performed to identify the expected amount of oil recovered using the chemical agent. Identifying fluid properties and performing the EOR simulation and EOR recovery analysis may be performed for each chemical agent. Comparing the simulation results of the analysis may be used to select an optimal chemical agent. Thus, the EOR injection operation is performed at the wellsite using the selected optimal chemical agent.

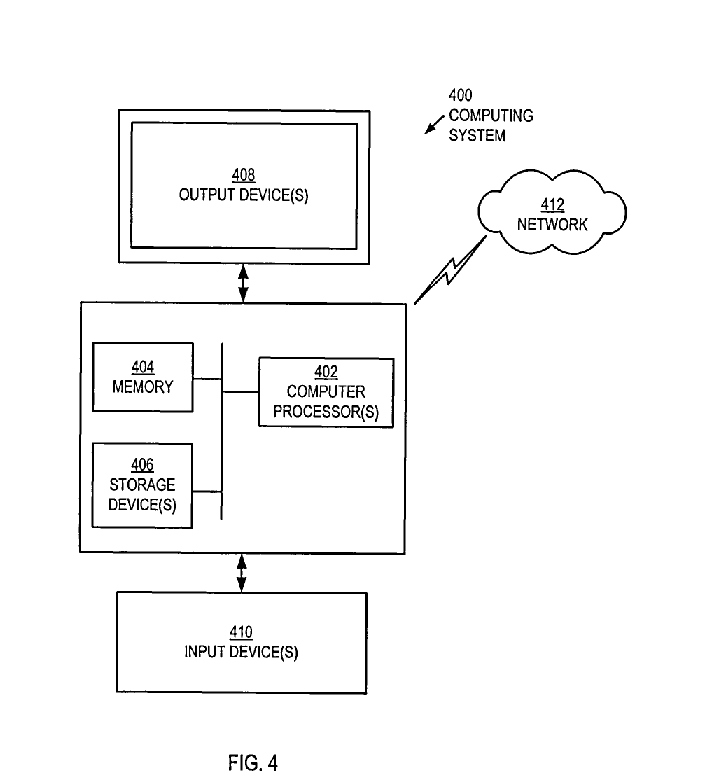

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (400) may be located at a remote location and connected to the other elements over a network (412). Further, embodiments may be implemented on a distributed system having a plurality of nodes, where each portion may be located on a different node within the distributed system. In one embodiment, the node corresponds to a distinct computing device. Further, the node may correspond to a computer processor with associated physical memory. The node may correspond to a computer processor or micro-core of a computer processor with shared memory and/or resources.

While the above has been described with respect to a limited number of embodiments, those skilled in the art, having benefit of this disclosure, will appreciate that other embodiments can be devised which do not depart from the scope as disclosed herein. Accordingly, the scope should be limited by the attached claims.

What is claimed is:

1. A method for performing an enhanced oil recovery (EOR) injection operation in an oilfield (120) having a reservoir (132), comprising:
obtaining a first plurality of EOR scenarios (194), each comprising a chemical agent;
obtaining a first three-dimensional (3D) porous solid image (190) of a first core sample, wherein the first core sample is a first 3D porous medium representing a first portion of the oilfield (120);
generating a first 3D pore scale model (192) from the first 3D porous solid image (190), wherein the first 3D pore scale model (192) describes a first physical pore structure in the first 3D porous medium;
performing a first plurality of simulations using the first plurality of EOR scenarios to obtain a first plurality of simulation results (196) by:
for each EOR scenario of the first plurality of EOR scenarios (194), simulating, on the first 3D pore scale model (192), the EOR injection operation using the chemical agent specified by the EOR scenario to generate a simulation result of the first plurality of simulation results (196);
performing a first comparative analysis of the first plurality of simulation results (196) to obtain a first selected chemical agent; and
performing a first operation using the first selected chemical agent.

2. The method of claim 1, wherein performing the first operation comprises storing the first selected chemical agent.

3. The method of claim 1, wherein performing the first operation comprises defining a strategy for the oilfield (120) based on the first selected chemical agent.

4. The method of claim 1, wherein performing the first operation comprises performing the EOR injection operation in the oilfield (120) using the first selected chemical agent.

5. The method of claim 1, wherein the first plurality of EOR scenarios are for the first portion of the oilfield (120), and wherein the method further comprises:
obtaining a second plurality of EOR scenarios (194) each comprising a chemical agent and an identifier of a second portion of the oilfield (120);
obtaining a second 3D porous solid image (190) of a second core sample, wherein the second core sample is a second 3D porous medium representing a second portion of the oilfield (120);
generating a second 3D pore scale model (192) from the second 3D porous solid image, wherein the second 3D pore scale model (192) describes a second physical pore structure in the second 3D porous medium;
performing a second plurality of simulations using the second plurality of EOR scenarios (194) to obtain a second plurality of simulation results (196) by:
for each EOR scenario of the second plurality of EOR scenarios (194), simulating, on the second 3D pore scale model (192), the EOR injection operation using the chemical agent specified by the EOR scenario to generate a simulation result of the second plurality of simulation results (196);
performing a second comparative analysis of the first plurality of simulation results (196) to obtain a second selected chemical agent; and
comparing the first selected chemical agent with the second selected chemical agent.

6. The method of claim 5, wherein, based on the comparing of the first selected chemical agent with the second selected chemical agent, the first operation is performed on the oilfield (120).

7. The method of claim 5, wherein, based on the comparing of the first selected chemical agent with the second selected chemical agent, the first operation is performed for the first portion of the oilfield (120), and a second operation is performed for the second portion of the oilfield (120).

8. The method of claim 7, wherein performing the second operation comprises storing the second selected chemical agent for the second portion of the oilfield (120).

9. The method of claim 7, wherein performing the first operation and the second operation comprises defining a first strategy for the first portion of the oilfield (120) based on the first selected chemical agent and defining a second strategy for the second portion of the oilfield (120) based on the second selected chemical agent.

10. The method of claim 7, wherein performing the second operation comprises performing the EOR injection operation in the second portion of the oilfield (120) using the second selected chemical agent.

11. A system for performing an enhanced oil recovery (EOR) injection operation in an oilfield (120) having a reservoir (132), comprising:
a computer processor (402); and
an EOR modeling tool (176) executing on the computer processor (402) and comprising:
an interface (182) configured to obtain a first plurality of EOR scenarios (194), each comprising a chemical agent,
a 3D pore scale model generator (184) configured to:
obtain a first three-dimensional (3D) porous solid image (190) of a first core sample, wherein the first core sample is a first 3D porous medium representing a first portion of the oilfield (120); and
generate a first 3D pore scale model (192) from the first 3D porous solid image (190), wherein the first 3D pore scale model (192) describes a first physical pore structure in the first 3D porous medium; and
an EOR simulator (188) configured to:
perform a first plurality of simulations using the first plurality of EOR scenarios (194) to obtain a first plurality of simulation results (196) by:
for each EOR scenario of the first plurality of EOR scenarios (194), simulating, on the first 3D pore scale model (192), the EOR injection operation using the chemical agent specified by the EOR scenario to generate a simulation result of the first plurality of simulation results (196); and
perform a first comparative analysis of the first plurality of simulation results (196) to obtain a first selected chemical agent,
wherein a first operation is performed using the first selected chemical agent.

12. The system of claim 11, wherein the EOR modeling tool further comprises:
an image generator (186) configured to generate an image of the simulation result.

13. The system of claim 11, further comprising:
a data repository (180) configured to store:
the first plurality of EOR scenarios (194),
the 3D pore scale model (192), and
the first plurality of simulation results (196).

14. The system of claim 11, wherein the first plurality of EOR scenarios are for the first portion of the oilfield (120),
wherein the interface is further configured to obtain a second plurality of EOR scenarios (194) each comprising a chemical agent and an identifier of a second portion of the oilfield (120),
wherein the 3D pore scale model generator (184) is further configured to:
obtain a second 3D porous solid image (190) of a second core sample, wherein the second core sample is a second 3D porous medium representing a second portion of the oilfield (120); and
generate a second 3D pore scale model (192) from the second 3D porous solid image (190), wherein the second 3D pore scale model (190) describes a second physical pore structure in the second 3D porous medium, and
wherein the EOR simulator (188) is further configured to:
perform a second plurality of simulations using the second plurality of EOR scenarios (194) to obtain a second plurality of simulation results (196) by:
for each EOR scenario of the second plurality of EOR scenarios (194), simulating, on the second 3D pore scale model (192), the EOR injection operation using the chemical agent specified by the EOR scenario to generate a simulation result of the second plurality of simulation results (196);
perform a second comparative analysis of the first plurality of simulation results (196) to obtain a second selected chemical agent; and
compare the first selected chemical agent with the second selected chemical agent.

15. The system of claim 14, wherein, based on the comparing of the first selected chemical agent with the second selected chemical agent, the first operation is performed on the oilfield (120).

16. The system of claim 14, wherein, based on the comparing of the first selected chemical agent with the second selected chemical agent, the first operation is performed for the first portion of the oilfield (120), and a second operation is performed for the second portion of the oilfield (120).

17. A computer program product comprising computer readable program code embodied therein for performing a method according to any of claims 1-10.
